(19) United States
(12) Patent Application Publication
(10) Pub. No.: US 2012/0210438 A1
(43) Pub. Date: Aug. 16, 2012

(54) Secure Three-Dimensional Mask-Programmed Read-Only Memory

(76) Inventor: Guobiao ZHANG, Corvallis, OR (US)

(21) Appl. No.: 13/027,274

(22) Filed: Feb. 15, 2011

(51) Int. Cl. G06F 21/24

(52) U.S. Cl. 726/26

(57) ABSTRACT

Among all classes of three-dimensional read-only memory (3D-ROM), mask-programmed 3D-ROM (3Dm-ROM) is suitable for mass information dissemination. A secure 3Dm-ROM (3Dm-ROMS) comprises a 3Dm-ROM for storing mass information, a non-mask-programmed memory (NMP) for storing at least a key and an encryption logic. It provides strong copyright protection by writing different keys into different NMPs and encrypting the 3Dm-ROM contents with these different keys.

### BACKGROUND

1. Technical Field of the Invention

The present invention relates to the field of integrated circuit, and more particularly to mask-programmed read-only memory (mask ROM) and its application to mass information dissemination.

2. Prior Arts

Mass information dissemination refers to mass distribution of mass information. “Mass information” contains gigabytes (GB) of data, even terabytes (TB) of data. Examples of mass information include moving images (e.g. movie, television programs, video, video game) and still images (e.g. photos, maps), audio contents (e.g. music, audio books), textual contents (e.g. books), software(s) and their libraries (e.g. movie library, game library, map library, music library, software library). “Mass distribution” means distributing hundreds of thousands of copies, even millions of copies, to both stationary users and mobile users. Before distribution, mass information is recorded and stored in mass storage. Mass storage prefers small physical size, low recording cost, low storage cost and strong copyright protection.

Three-dimensional read-only memory (3D-ROM) is considered ideal for mass information dissemination. U.S. Pat. No. 5,835,396 issued to Zhang on Nov. 10, 1998 discloses a 3D-ROM. It is a monolithic semiconductor memory. As illustrated in FIG. 1, a typical 3D-ROM comprises a semiconductor substrate 00 and a 3D-ROM stack 10. The semiconductor substrate 00 comprises transistors and their interconnects, which form the peripheral circuit and other functions. The 3D-ROM stack 10 comprises a plurality of memory levels (e.g. 100, 200), which are stacked above one another and further above the substrate 00. Each memory level (e.g. 100) comprises a plurality of address lines (e.g. 1a . . . ; 2a . . . ) and memory cells (e.g. 5aa). Memory cells (e.g. 5aa) are formed at the intersection between two address-selection lines (e.g. 1a and 2a). Contact vias (e.g. 1av, 3av) couple memory levels (e.g. 100, 200) to the substrate 00. Based on how data are recorded, 3D-ROM can be categorized into two classes: electrically-programmable 3D-ROM (3D-EPROM) and mask-programmed 3D-ROM (3Dm-ROM, or 3D-MPROM in prior patents/applications).

3D-EPROM refers to the 3D-ROM whose data are electrically written. Examples of 3D-EPROM include 3D-OTP (3-D one-time programmable memory) and 3D-RW (3-D read-write memory). FIG. 2 illustrates a typical 3D-EPROM cell 5e. It comprises a diode layer 7d and an antifuse layer 7a. The electrical resistance of the diode layer 7d is higher when current flows in one direction than in the opposite direction. The antifuse layer 7a is an insulating layer before programming. It can be ruptured and become conductive after programming. The antifuse integrity represents the digital state of the memory cell.

3Dm-ROM refers to the 3D-ROM whose data are defined by mask(s) during manufacturing. FIGS. 3A-3B illustrate two typical 3Dm-ROM cells 5m0, 5m1. The 3Dm-ROM cell 5m0 in FIG. 3A represents digital “0”. It comprises a blocking dielectric 7b, which electrically isolates two address-section lines 1a and 2a. The 3Dm-ROM cell 5m1 in FIG. 3B represents digital “1”. It further comprises a contact 7c, which is formed in the blocking dielectric 7b and couples the two address-section lines 1a and 2a. In the present invention, a phrase “batch” is used to indicate all memory devices whose data are defined by the same mask set. For example, in a 3Dm-ROM batch, every 3Dm-ROM has its data defined by the same mask set and therefore, stores the same data.

It is well know to those skilled in the art that, 3D-EPROM was considered as the most promising 3D-ROM and has been the major focus of research and development; whereas, 3Dm-ROM was considered as a variant of the traditional mask ROM, which is getting obsolete. However, as is inherent with any diode-based matrix-type memory, 3D-EPROM has a slow write speed. With a typical write speed of ˜1.5 MB/s (referring to “Sandisk 3D-OTP Memory Specifications”), it takes a long time to record mass information, e.g. ˜3 hours to record a high-definition movie, or ˜20 GB. This long recording time and the associated high recording cost makes 3D-EPROM unsuitable for mass information dissemination.

On the other hand, the copyright protection provided by 3Dm-ROM is weaker than 3D-EPROM. Because the 3Dm-ROM's from the same 3Dm-ROM batch store the same data, even if these data are encrypted, they are encrypted by the same key or the same set of keys. Once the key(s) from a single 3Dm-ROM is leaked, all other 3Dm-ROM's from the same batch will be compromised. This happened before to optical storage (i.e. DeCSS to DVD). In contrast, because the data in each 3D-EPROM are individually written, the information stored in different 3D-EPROMs can be encrypted with different keys. Hence, even if the key(s) from a single 3D-EPROM is leaked, other 3D-EPROMs storing the same information will not be compromised.

The prior arts failed to identify the 3D-ROM class which is suitable for mass information dissemination, let alone protect copyright to the mass information stored in the identified 3D-ROM class. To overcome these deficiencies, the present invention discloses a secure three-dimensional mask-programmed read-only memory (3Dm-ROM_{S}).

### OBJECTS AND ADVANTAGES

It is a principle object of the present invention to identify the 3D-ROM class which is suitable for mass information dissemination.

It is a further object of the present invention to protect copyright to the mass information stored in the identified 3D-ROM class.

In accordance with these and other objects of the present invention, a secure three-dimensional mask-programmed read-only memory (3Dm-ROMs) is disclosed.

### SUMMARY OF THE INVENTION

3D-EPROM writes data electrically. Due to its slow write speed (−1.5 MB/s), 3D-EPROM requires a long time to record mass information, e.g. ˜3 hours to record a high-definition movie, or ˜20 GB. This fundamental flaw makes 3D-EPROM unsuitable for mass information dissemination. In contrast, 3Dm-ROM prints data optically: data images are transferred into 3Dm-ROM via mask(s) during photolithography step(s). Photolithography can rapidly and economically reproduce data images on a large number of dice. For example, ˜20 GB of data (enough for a high-definition movie) can be printed onto hundreds of dice in a single photolithography step. Photolithography—this large-scale industrial printing process—makes 3Dm-ROM suitable for mass information dissemination.

It might be a surprise to those skilled in the art that 3Dm-ROM is more suitable for mass information dissemination than 3D-EPROM. In fact, this conclusion is not too difficult to be understood by reviewing optical storage. At present, movies are released in Blu-ray read-only disc (BD) instead of Blu-ray recordable disc (BD-R) or Blu-ray rewritable disc (BD-RE). This is because, BD, which prints movie data via a disc master, can rapidly and economically reproduce movie data on a large scale, whereas BD-R and BD-RE, which write movie data, require a long time (e.g. ˜20 minutes) to record a high-definition movie and this makes it unsuitable for mass reproduction. In sum, similar to traditional publication (e.g. on paper), in semiconductor storage and optical storage, printing is more suitable for mass information dissemination than writing.

As the mass storage of choice, 3Dm-ROM should provide strong copyright protection for its contents. Accordingly, the present invention discloses a secure 3Dm-ROM (3Dm-ROMs). It comprises a 3Dm-ROM, a non-mask-programmed memory (NMP) and an encryption logic. The 3Dm-ROM stores mass information. The NMP stores encryption key(s). It is a non-volatile memory that can be written by non-mask-programming means, e.g. optical, electrical, or magnetic means. The encryption logic provides means for encrypting information data with a key. By writing different keys into different NMPs and encrypting the 3Dm-ROM contents with these different keys, strong copyright protection can be achieved. To be more specific, even if the key(s) from a single 3Dm-ROM_{S} is leaked, other 3Dm-ROM_{S}'s storing the same information will not be compromised. In sum, the copyright protection provided by 3Dm-ROM_{S} is stronger than 3Dm-ROM, and is as strong as 3D-EPROM. It should be noted that, even though they are both printed storage, 3Dm-ROM_{S} provides stronger copyright protection than optical storage (e.g. DVD, BD).

### BRIEF DESCRIPTION OF THE DRAWINGS

FIG. 1 is a cross-sectional view of a three-dimensional read-only memory (3D-ROM);

FIG. 2 is a cross-sectional view of an electrically-programmable 3D-ROM (3D-EPROM) cell;

FIGS. 3A-3B are cross-sectional views of mask-programmed 3D-ROM (3Dm-ROM) cells at states “0” and “1”, respectively;

FIG. 4 is a block diagram of a preferred 3Dm-ROM_{S};

FIG. 5 is a block diagram of another preferred 3Dm-ROM_{S};

FIG. 6 is a cross-sectional view of a preferred 3Dm-ROM_{S} chip;

FIG. 7 is a top view of the preferred 3Dm-ROM_{S} chip, showing 3Dm-ROM array and its peripheral circuit;

FIGS. 8A-8C illustrate three cases of the same chip from FIG. 7 with the 3Dm-ROM array not shown, revealing the substrate;

FIG. 9 is a cross-sectional view of a preferred 3Dm-ROM_{S} module;

FIGS. 10AA-10BB illustrate two cases of 3Dm-ROM chip and support chip in the preferred 3Dm-ROM_{S} module of FIG. 9.

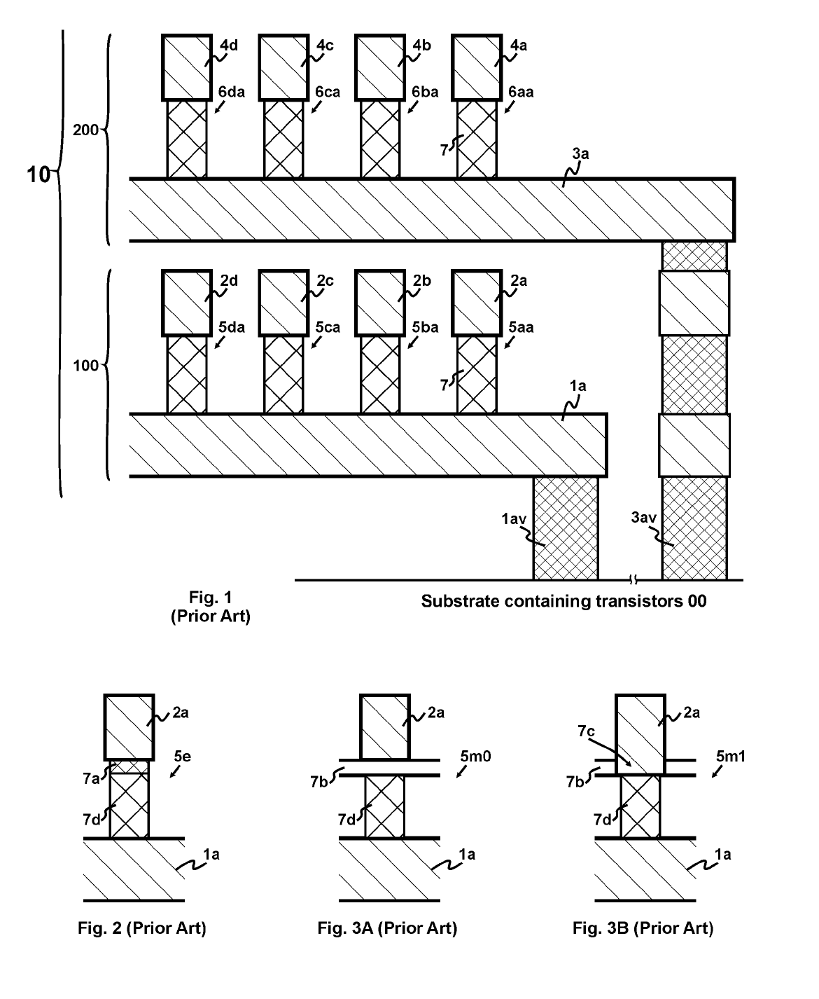

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

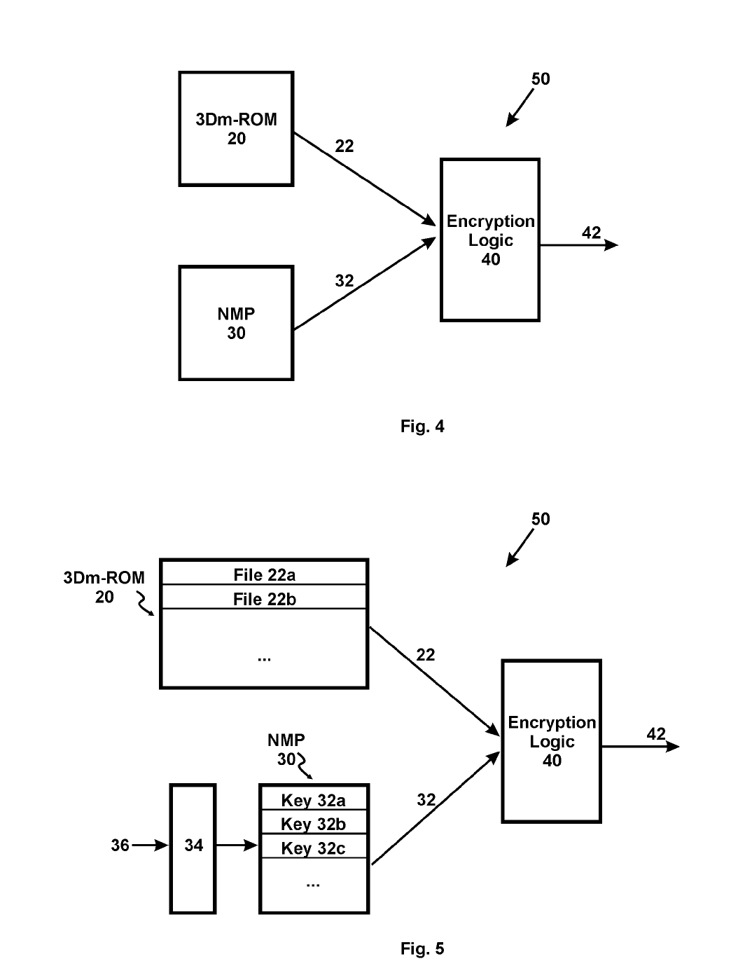

Referring to FIG. 4, a preferred secure 3Dm-ROM (3Dm-ROM_{S}) 50 is disclosed. It comprises a 3Dm-ROM 20, a non-mask-programmed memory (NMP) 30 and an encryption logic 40. The 3Dm-ROM 20 stores mass information. The NMP 30 stores encryption key(s). The encryption logic 40 encrypts information data 22 with a key 32. Its readout 42 is the 3Dm-ROM_{S} output.

The NMP 30 is a non-volatile memory that can be written by non-mask-programming means, e.g. optical, electrical, or magnetic means. Key(s) can be written into the NMP during/after manufacturing. Examples of NMP include laser-programmable read-only memory (LP-ROM) and electrically writable read-only memory. Here, electrically-writable read-only memory includes programmable read-only memory (PROM, e.g. antifuse-based or fuse-based), electrically programmable read-only memory (EPROM, including 3D-EPROM), and electrically erasable programmable read-only memory (E²PROM, including flash memory).

The encryption logic 40 transforms information data 22 using an algorithm to make it unreadable to anyone except those possessing the key 32. Different encryption algorithms may be employed, e.g. PGP, AES, 3DES, Blowfish, or others. The encryption logic 40 could also be a data scrambler, which rearranges data 22 according to a pattern defined by the key 32. To improve the efficiency of the encryption logic 40, data 22 may be partially encrypted.

In a 3Dm-ROM_{S} batch, every 3Dm-ROM stores the same data. By writing different keys into different NMPs and encrypting the 3Dm-ROM contents with these different keys, strong copyright protection can be achieved. For example, two 3Dm-ROM_{S}'s (A and B) from the same 3Dm-ROM_{S} batch store the same information, but are encrypted with two different keys. Even if the key(s) from a single 3Dm-ROM_{S} (e.g. A) is leaked, other 3Dm-ROM_{S}'s storing the same information (e.g. B) will not be compromised. In sum, the copyright protection provided by 3Dm-ROM_{S} is stronger than 3Dm-ROM, and is as strong as 3D-EPROM. It should be noted that, even though they are both printed storage, 3Dm-ROM_{S} provides stronger copyright protection than optical storage (e.g. DVD, BD).

Referring now to FIG. 5, another preferred 3Dm-ROM_{S} 50 is disclosed. It further enhances copyright protection by providing file-dependent encryption and/or time-variant encryption. The preferred embodiment in FIG. 5 comprises a 3Dm-ROM 20, an NMP 30, a key-selection logic 34 and an encryption logic 40. The 3Dm-ROM 20 stores at least one data file 22a . . . , and the NMP 30 stores a plurality of keys 32a, 32b . . . . The key-selection logic 34 selects key(s) based on input 36 such as file address, time or other information.

When the key is selected based on file address, different data files are encrypted by different keys. For example, data file 22a is encrypted by key 32a, while data file 22b is encrypted by key 32b . . . . On the other hand, when the key is selected based on time, data files are encrypted by different keys during different time periods. For example, data file 22a is encrypted by key 32a during the time period A, and encrypted by key 32c during the time period B . . . All these features add complexity to breaking into 3Dm-ROM_{S} and further enhance its copyright protection. Apparently, other copyright-enhancing techniques can also be used, e.g. different portions of the data file can be encrypted by different keys.

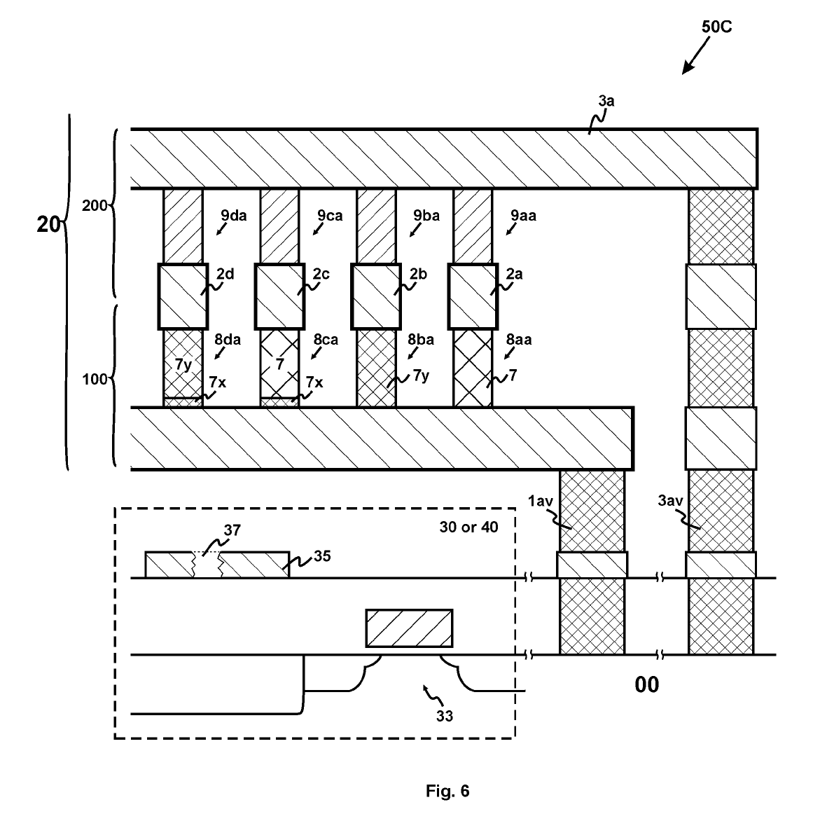

FIG. 6 illustrates a cross-sectional view of a preferred 3Dm-ROM_{S} chip 50C. In this preferred embodiment, the 3Dm-ROM 20, the NMP 30 and the encryption logic 40 are integrated into a single chip. Because all data connections are located inside the chip 50C and data flows are not easy to be tampered with, this preferred embodiment provides excellent copyright protection. Here, the 3Dm-ROM array 20 is formed above and coupled to the substrate 00 via contact vias lay, 3ay . . . . It comprises a plurality of memory levels (e.g. 100, 200 . . . ). The 3Dm-ROM can improve its storage density by using multi-bit-per-cell (referring to U.S. patent application Ser. No. 12/785,621, “Large bit-per-cell Three-Dimensional Mask-Programmable Read-Only Memory”, filed on May 24, 2010), i.e. each memory cell (e.g. 8aa-8da . . . ) stores multiple bits by adding resistive layer 7x or implanting resistive element 7y. The 3Dm-ROM can further improve its storage density by using a hybrid-level structure (referring to U.S. patent application Ser. No. 12/476,263, “Hybrid-Level Three-Dimensional Mask-Programmable Read-Only Memory”, filed on Jun. 2, 2009), i.e. some address-selection lines (e.g. 2a-2d . . . ) are shared by adjacent memory levels (e.g. 100, 200). At the F=20 nm node, a 3Dm-ROM with 8 memory levels and 2 bits per cell can reach a storage density of

(# of memory levels)*(# of bits per cell)/4 F²=(8*2)/(4*20 nm²)=1 Tb/cm².

In the preferred 3Dm-ROMs chip 50C of FIG. 6, the NMP 30 and the encryption logic 40 are preferably located below 3Dm-ROM array 20. In other words, they are formed before the 3Dm-ROM array during manufacturing. Because their building blocks are transistors 33, at least a portion of the NMP 30 and the encryption logic 40 are formed in the substrate 00. Here, the phrase “in the substrate” should be interpreted as “in the substrate” or “on the substrate”. In this preferred embodiment, the NMP 30 is a laser-programmable read-only-memory (LP-ROM). It comprises a laser-programmable fuse 35 and can be programmed during manufacturing, e.g. before the 3Dm-ROM array is formed. By shining a laser beam onto the fuse 35, a gap 37 can be formed in the fuse 35. The existence or absence of the gap 37 indicates the digital state of the LP-ROM cell. Among all types of NMP, LP-ROM is particularly advantageous because it does not require high-voltage programming transistor and incurs minimum process change.

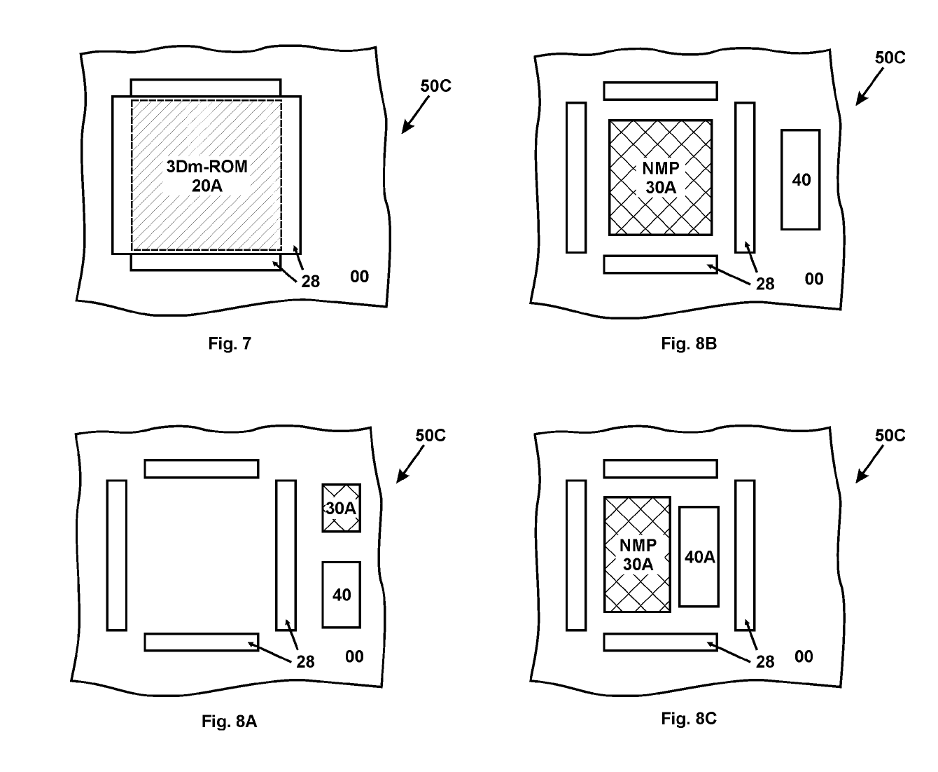

FIG. 7 is a top view of the preferred 3Dm-ROM_{S} chip 50C, showing the 3Dm-ROM array 20A (shaded areas) and its associated peripheral circuit 28. FIGS. 8A-8C illustrate three cases of the same chip with 3Dm-ROM array 20A not shown, revealing the substrate 00. In FIG. 8A, the NMP 30 and the encryption logic 40 are formed on the substrate 00 but outside the 3Dm-ROM array 20A. In FIG. 8B, the NMP 30A is formed underneath the 3Dm-ROM array 20A. The encryption logic 40 is formed outside the 3Dm-ROM array 20A. It can be shared by 3Dm-ROM arrays. In FIG. 8C, both the NMP 30A and the encryption logic 40A are formed underneath the 3Dm-ROM array 20A. In FIGS. 8B-8C, at least the NMP 30A is formed underneath the 3Dm-ROM array 20A. To uncover the underlying NMP 30A, it would require removal of the 3Dm-ROM array 20A. This defies the whole purpose of pirating. Note FIGS. 7-8C and FIGS. 10AA-10BB are merely representative and are not intended to indicate any actual layout. Layout is a design choice and many configurations are possible.

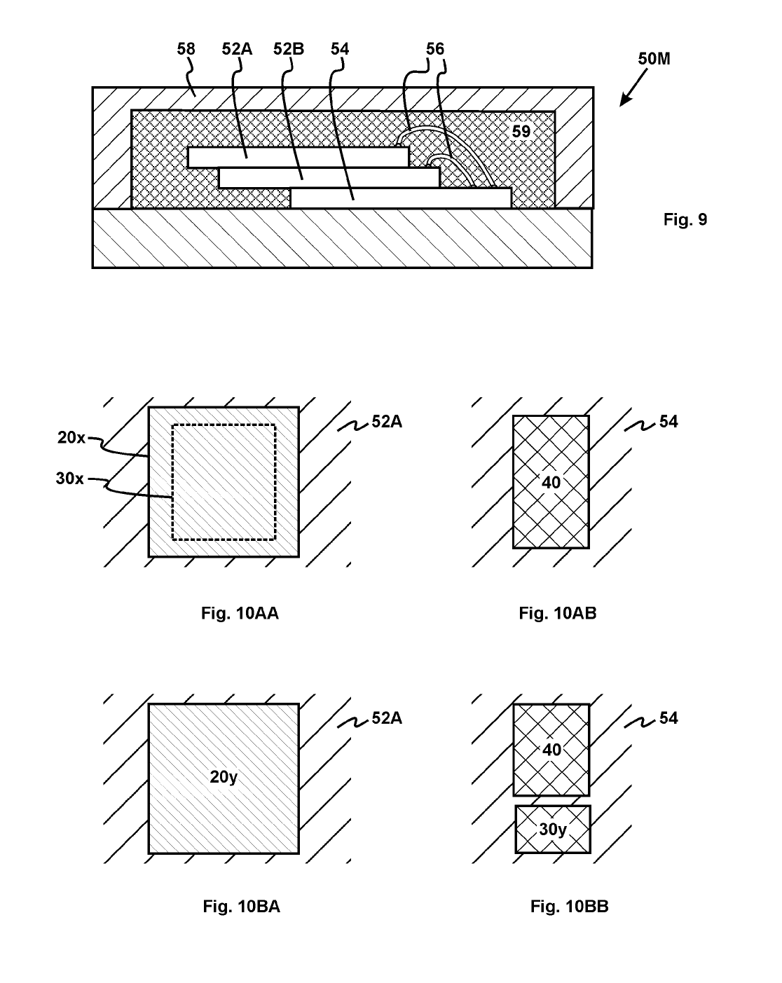

FIG. 9 illustrates a cross-sectional view of a preferred 3Dm-ROM_{S} module 50M. In this preferred embodiment, the 3Dm-ROM 20, the NMP 30 and the encryption logic 40 are integrated into a single protective package 50M. It comprises at least one 3Dm-ROM chip 52A, 52B . . . and a support chip 54. Each 3Dm-ROM chip (e.g. 52A) comprises a plurality of memory levels. The support chip 54 can be a controller chip. All these chips (52A, 52B . . . , 54) are preferably stacked above one another and coupled to each other through bonding wires 56, then placed in a secure housing 58 filled with protective materials 59 such as molding compound.

FIGS. 10AA-10BB illustrate two cases of the preferred 3Dm-ROM chip 52A and support chip 54 in the preferred 3Dm-ROM_{S} module 50M. In the case of FIGS. 10AA-10AB, the 3Dm-ROM chip 52A comprises at least one 3Dm-ROM array 20x (shaded area) and at least one NMP array 30x. The NMP array 30x is located underneath the 3Dm-ROM array 20x (FIG. 10AA). In the meantime, the support chip 54 comprises the encryption logic 40 (FIG. 10AB). In the case of FIGS. 10BA-10BB, the 3Dm-ROM chip 52A comprises at least one 3Dm-ROM array 20y (FIG. 10BA), while the support chip 54 comprises at least one NMP array 30y and the encryption logic 40 (FIG. 10BB). By integrating the 3Dm-ROM, the NMP and the encryption logic into a single protective package 50M, this preferred embodiment also provides strong copyright protection.

While illustrative embodiments have been shown and described, it would be apparent to those skilled in the art that may more modifications than that have been mentioned above are possible without departing from the inventive concepts set forth therein. For example, the 3D-ROM disclosed in the present invention is based on diodes. In fact, it can be based on transistors and other devices. The invention, therefore, is not to be limited except in the spirit of the appended claims.

What is claimed is:

1. A secure three-dimensional mask-programmed read-only memory, comprising:
a three-dimensional mask-programmed read-only memory (3Dm-ROM) for storing mass information;
a non-mask-programmed memory (NMP) for storing at least a key;
and means for encrypting selected data from said mass information with said key.

2. The secure three-dimensional mask-programmed read-only memory according to claim 1, further comprising means for selecting a key from said NMP.

3. The secure three-dimensional mask-programmed read-only memory according to claim 1, wherein said 3Dm-ROM, said NMP and said encrypting means are formed in a single chip.

4. The secure three-dimensional mask-programmed read-only memory according to claim 3, wherein the memory array of said 3Dm-ROM is formed above and coupled to the substrate of said chip, said NMP and said encrypting means are formed below the memory array of said 3Dm-ROM.

5. The secure three-dimensional mask-programmed read-only memory according to claim 4, wherein said NMP and/or said encrypting means is formed in the substrate of said chip.

6. The secure three-dimensional mask-programmed read-only memory according to claim 4, wherein said NMP and/or said encrypting means is formed underneath the memory array of said 3Dm-ROM.

7. The secure three-dimensional mask-programmed read-only memory according to claim 1, wherein said 3Dm-ROM, said NMP and said encrypting means are formed in a single module.

8. The secure three-dimensional mask-programmed read-only memory according to claim 7, wherein said module further comprises a support chip, said support chip comprising said NMP.

9. The secure three-dimensional mask-programmed read-only memory according to claim 7, wherein said module further comprises a support chip, said support chip comprising said encrypting means.

10. The secure three-dimensional mask-programmed read-only memory according to claim 1, wherein said NMP is a non-mask-programmed non-volatile memory.

11. The secure three-dimensional mask-programmed read-only memory according to claim 10, wherein said NMP is a laser-programmable read-only memory or an electrically-writable read-only memory.

12. A secure three-dimensional mask-programmed read-only memory chip, comprising:
a semiconductor substrate containing transistors;
a three-dimensional mask-programmed read-only memory (3Dm-ROM) array stacked above and coupled to said substrate;
a non-mask-programmed memory (NMP) for storing at least a key;
and means for encrypting selected data from said 3Dm-ROM array with said key.

13. The secure three-dimensional mask-programmed read-only memory chip according to claim 12, further comprising means for selecting a key from said NMP.

14. The secure three-dimensional mask-programmed read-only memory chip according to claim 12, wherein said NMP and said encrypting means are formed below said 3Dm-ROM array.

15. The secure three-dimensional mask-programmed read-only memory chip according to claim 13, wherein said NMP and/or said encrypting means is formed in said substrate.

16. The secure three-dimensional mask-programmed read-only memory chip according to claim 13, wherein said NMP and/or said encrypting means is formed underneath said 3Dm-ROM array.

17. A secure three-dimensional mask-programmed read-only memory module, comprising:
at least one three-dimensional mask-programmed read-only memory (3Dm-ROM) chip;
a non-mask-programmed memory (NMP) for storing at least a key;
and a support chip comprising means for encrypting selected data from said 3Dm-ROM chip with said key.

18. The secure three-dimensional mask-programmed read-only memory module according to claim 17, further comprising means for selecting a key from said NMP.

19. The secure three-dimensional mask-programmed read-only memory module according to claim 17, wherein said 3Dm-ROM chip comprises said NMP.

20. The secure three-dimensional mask-programmed read-only memory module according to claim 17, wherein said support chip comprises said NMP.
